(19) United States
(12) Patent Application Publication
(10) Pub. No.: US 2013/0252726 A1
(43) Pub. Date: Sep. 26, 2013

(54) SYSTEM AND METHOD FOR OPERATING GAME IN ASSOCIATION WITH GOODS-RELATED CHARACTER/ITEM

(71) Applicant: CALM ISLAND CO., LTD., Seoul (KR)

(72) Inventor: David Northam Roberts, Seoul (KR)

(73) Assignee: CALM ISLAND CO., LTD., Seoul (KR)

(21) Appl. No.: 13/747,808

(22) Filed: Jan. 23, 2013

(30) Foreign Application Priority Data
Mar. 26, 2012 (KR) 10-2012-0030460

(51) Int. Cl. A63F 13/12

(52) U.S. Cl. CPC A63F 13/12
USPC 463/29; 463/42

(57) ABSTRACT

Disclosed herein is a system and method for operating a game in association with a goods-related character/item. The system includes a tag sticker attached to goods and storing game information related to the goods, and a mobile terminal acquiring and storing the game information from the tag sticker through near field communication, wherein the game information is stored in association with a game a user desires to play, such that the game information is applied to the game in execution of the game.

### CROSS-REFERENCE TO RELATED APPLICATION

This application claims the benefit under 35 U.S.C. § 119 of Korean Patent Application No. 10-2012-0030460, filed on Mar. 26, 2012 in the Korean Intellectual Property Office, the entirety of which disclosure is incorporated herein by reference.

### BACKGROUND

1. Technical Field

Embodiments of the present invention relate to a game operating system and method, and more particularly, to a game operating system and method in which a goods-related character/item is acquired through near field communication (NFC) and applied to a game.

2. Description of the Related Art

Recently, the variety of mobile games executable in a mobile terminal has increased and game quality has been enhanced. Accordingly, a lot of mobile terminals capable of executing various mobile games have been released and performance of the mobile terminal has continuously increased.

A display for mobile terminals such as mobile phones provides a small screen only suitable for single-player gaming. However, as a TV-out function has been generalized in recent years, a small screen image on the display can be displayed on a large

TV screen such that a plurality of users can play a mobile game simultaneously.

Meanwhile, near field communication (NFC) is very short-range contactless data transfer technology associated with radio frequency identification (RFID). In Europe and Japan, NFC has brought commercial success in a point-of-sale purchase and a public transport payment system using a cellular phone with a built-in NFC interface.

Accordingly, there is a need for a system and a method for operating a mobile game in association with a tag sticker through NFC or like near field communication.

As a related technology, Korean Patent No. 10-0715972 (registered on May 2, 2007) discloses a game operating method, entitled “game method using mobile terminal with near field communication function”.

### BRIEF SUMMARY

Embodiment of the present invention provide a system and method for operating a game in association with a goods-related character/item, in which game information (i.e., a character/item) related to goods is acquired through near field communication between a tag sticker of the goods and a mobile terminal and applied to a game, so that a user can play the game with an updated character/item when the game is executed.

In accordance with an aspect, the present invention provides a system for operating a game in association with a goods-related character/item, which includes a tag sticker attached to goods and storing game information related to the goods; and a mobile terminal acquiring and storing the game information from the tag sticker through near field communication, wherein the game information is stored in association with a game a user desires to play, such that the game information is applied to the game in execution of the game.

The game information may include at least one of a character and an item related to the goods.

The tag sticker may be kept in a security setting state before the goods are sold at a predetermined selling place, and kept in a security release state after the goods are sold at the selling place.

The mobile terminal may acquire the game information from the tag sticker when the security setting state of the tag sticker is released.

The mobile terminal may include a reader unit acquiring the game information from the tag sticker through near field communication; a memory storing the game information acquired by the reader unit, such that the game information is stored in association with the game a user desires to play; and a game module executing the game according to user manipulation, and controlling the game information to be loaded from the memory and applied to the game in execution of the game.

The reader unit may include a near field communication (NFC) reader which performs NFC communication with the tag sticker.

The system may further include: a game server which updates the existing game information by receiving the game information from the mobile terminal and storing the game information in association with registration information of a user, and transmits the updated game information to the mobile terminal in response to a connection request from the mobile terminal by execution of the game.

In accordance with another aspect, the present invention provides a method for operating a game in association with a goods-related character/item includes: by a reader unit of a mobile terminal, acquiring game information related to goods from a tag sticker through near field communication; by a memory of the mobile terminal, storing the game information acquired by the reader unit such that the game information is stored in association with a game a user desires to play; and by a game module of the mobile terminal, executing the game according to user manipulation, and controlling the game information to be loaded from the memory and applied to the game in execution of the game.

The acquiring game information may include acquiring the game information from the tag sticker through near field communication with the tag sticker.

The method may further include, by the game server, updating the existing game information by receiving the game information from the mobile terminal and storing the game information in association with registration information of a user; and by the game server, transmitting the updated game information to the mobile terminal in response to the connection request from the mobile terminal by execution of the game.

According to one embodiment of the present invention, game information (character/item) related to goods is acquired through near field communication (NFC) between a tag sticker of the goods and a mobile terminal and applied to a game, so that a user can play the game with an updated character/item when the game is executed.

Accordingly, a user can play the game with a desired character, whereby user interest in the game is improved, thereby promoting goods sale.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 shows a network configuration of a system for operating a game in association with a goods-related character/item according to one embodiment of the present invention;

FIG. 2 is a block diagram of a mobile terminal of FIG. 1;

FIG. 3 is a flowchart of a method for operating a game in association with a goods-related character/item according to one embodiment of the present invention; and

FIG. 4 is a flowchart of a method for operating a game in association with a goods-related character/item according to another embodiment of the present invention.

### DETAILED DESCRIPTION

Hereinafter, embodiments of the present invention will be described in detail with reference to the accompanying drawings. However, it should be understood that the present invention is not limited to the following embodiments and may be embodied in different ways, and that the embodiments are provided for complete disclosure and thorough understanding of the present invention by those skilled in the art. The scope of the invention is defined only by the claims. The same components will be denoted by the same reference numerals throughout the drawings.

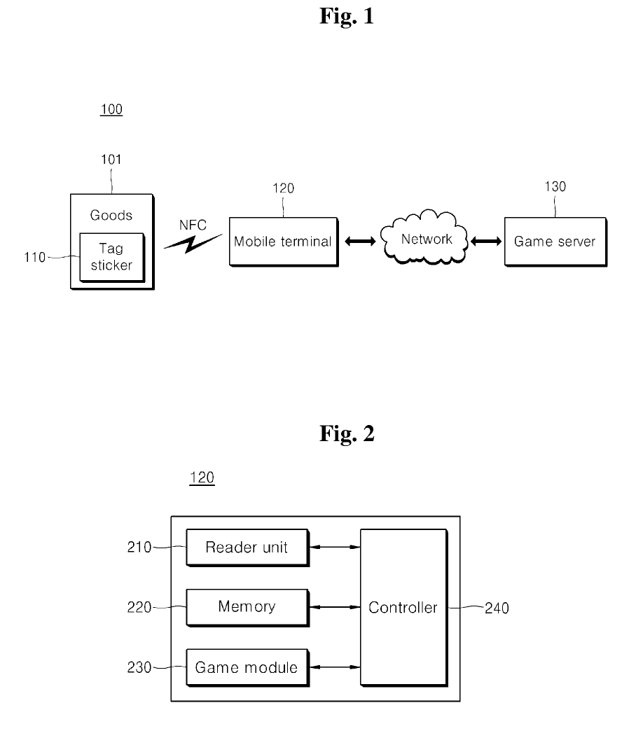

FIG. 1 shows a network configuration of a system for operating a game in association with a goods-related character/item according to one embodiment of the present invention;

Referring to FIG. 1, a system 100 for operating a game in association with a goods-related character/item according to one embodiment of the present invention may include a tag sticker 110, a mobile terminal 120, and a game server 130.

The tag sticker 110 is attached to goods 101, and stores game information associated with the goods 101. Here, the game information may include at least one of a character and an item related to the goods 101.

The tag sticker 110 may include a near field wireless communication module to perform near field wireless communication with the mobile terminal 120. In this embodiment, it is assumed that the near field wireless communication module is realized by a near field communication (NFC) module.

The tag sticker 110 may be kept in a security setting state before the goods 101 are sold at a predetermined selling place. Further, the tag sticker 110 may be kept in a security release state after the goods 101 are sold at a predetermined selling place.

For this purpose, the selling place may be provided with a security setting/release device. The security setting/release device may receive a goods-selling signal from a vendor of the selling place when the goods 101 are sold. The security setting/release device may release the security setting state of the tag sticker 110 in response to the goods-selling signal.

Thus, the security setting state of the tag sticker 110 is not released until the goods 101 are sold, thereby preventing a user (purchaser) from acquiring the goods-related character/item from the tag sticker 110 through a user's mobile terminal 120 at the selling place before the goods 101 are sold.

The mobile terminal 120 acquires and stores the game information (i.e., the goods-related character/item) from the tag sticker 110. At this time, the mobile terminal 120 stores the game information in connection with a game a user desires to play, such that the game information is applied to the game in execution of the game.

The mobile terminal 120 performs NFC communication with the NFC module of the tag sticker 110 to acquire the game information from the tag sticker 110. Here, the mobile terminal 120 may acquire the game information from the tag sticker 110 when the security setting state of the tag sticker 110 is released.

The mobile terminal 120 may execute a game without accessing the game server 130 when the game is executable in the mobile terminal. That is, the mobile terminal 120 stores the game information therein and loads the stored game information as the game is executed, thereby updating (changing) the character/item of the game.

On the other hand, the mobile terminal 120 may transmit the game information to the game server 130 when the game is not executable in the mobile terminal but executable through electronic connection. Detailed configurations of the mobile terminal 120 will be described with reference to FIG. 2.

The game server 130 may receive the game information from the mobile terminal 120. The game server 130 may store the received game information in association with registration information of a user. Thus, the game server 130 may update the game information.

Here, the registration information may include membership information input when a user joins a web site linked to the game server 130.

In response to a connection request from the mobile terminal 120 due to execution of the game, the game server 130 may connect with the mobile terminal 120 and transmit the updated game information to the mobile terminal 120.

Then, a user can play the game with the updated game information when the game is executed. Particularly, if a user is a child, the child can play the game with a desired character (for example, Hello Kitty, Doraemon, Pororo, etc.) in execution of the game, whereby user interest in the game is improved, thereby promoting goods sale.

FIG. 2 is a block diagram of a mobile terminal of FIG. 1.

Referring to FIGS. 1 and 2, the mobile terminal 120 may include a reader unit 210, a memory 220, a game module 230, and a controller 240.

The reader unit 210 acquires game information from the tag sticker 110. Here, the game information may include at least one of a character and an item related to the goods as described above.

The reader unit 210 may include an NFC reader which performs NFC communication with the tag sticker 110. In this embodiment, the NFC reader is used to perform the NFC communication with the tag sticker 110.

The memory 220 stores the game information acquired by the reader unit 210. At this time, the memory 220 may store the game information in association with a game a user desires to play.

For this purpose, a user selects a desired game through a menu on the mobile terminal 120 and stores the game information in the memory 220 by matching the game information with the selected game.

The game module 230 executes the game according to user menu manipulation of the mobile terminal 120. The game module 230 loads the game information from the memory 220 and applies the information to the game in execution of the game.

That is, the game module 230 may use the loaded game information to update the character or the item of the data related to the game. Thus, a user can play the game using the updated character or item.

Meanwhile, the game module 230 accesses the corresponding game server 130 in execution of the game and transmits the game information stored in the memory 220 to the game server 130. Then, the game module 230 receives game execution data, to which the updated (changed) game information is applied, from the game server 130, and uses the received game execution data to continue to execute the game.

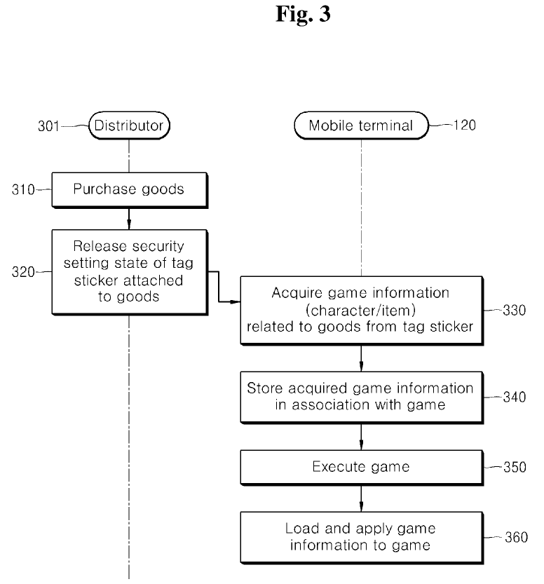

FIG. 3 is a flowchart of a method for operating a game in association with a goods-related character/item according to one embodiment. In particular, FIG. 3 shows the method of operating the game that is executed by the mobile terminal.

Referring to FIG. 3, in operation 310, a distributer 301 sells goods to which a tag sticker is attached.

Next, in operation 320, the distributer 301 releases a security setting state of the tag sticker attached to the goods.

Next, in operation 330, the mobile terminal 120 acquires game information (character/item) related to the goods from the tag sticker.

Next, in operation 340, the mobile terminal 120 stores the acquired game information in association with the game.

Next, in operation 350, the mobile terminal 120 executes the game according to user manipulation.

Next, in operation 360, the mobile terminal 120 loads the game information to apply the information to the game. Accordingly, a user can play the game through the updated game information.

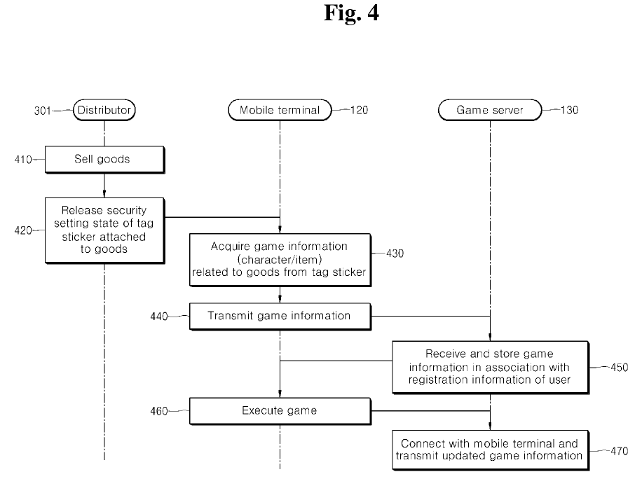

FIG. 4 is a flowchart of a method for operating a game in association with a goods-related character/item according to another embodiment. In particular, FIG. 4 shows the method of operating a game that is executed through electronic connection of a mobile terminal.

Referring to FIG. 4, in operation 410, a distributer 301 sells goods to which a tag sticker is attached.

Next, in operation 420, the distributer 301 releases a security setting state of the tag sticker attached to the goods.

Next, in operation 430, the mobile terminal 120 acquires game information (character/item) related to the goods from the tag sticker.

Next, in operation 440, the mobile terminal 120 transmits the acquired game information to the game server 130.

Next, in operation 450, the game server 130 receives the game information and stores the received game information in association with registration information of a user.

Next, in operation 460, the mobile terminal 120 executes a game according to user manipulation.

Next, in operation 470, the game server 130 connects with the mobile terminal 120 and transmits updated game information to the mobile terminal 120. Thus, a user can play the game based on the updated game information.

Thus, according to one embodiment of the invention, the game information (character/item) related to the goods is acquired through near field communication (NFC) between the tag sticker of the goods and the mobile terminal and applied to the game, so that a user can play the game with the updated character/item in execution of the game.

Accordingly, a user can play the game with a desired character in execution of the game, whereby user interest in the game is improved, thereby promoting goods sale.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD-ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by a computer using an interpreter. The described hardware devices may be configured to act as one or more software modules in order to perform the operations of the above-described exemplary embodiments of the present invention.

Although some embodiments have been described herein, it should be understood by those skilled in the art that these embodiments are given by way of illustration only, and that various modifications, variations, and alterations can be made without departing from the spirit and scope of the disclosure. Therefore, the scope of the disclosure should be limited only by the accompanying claims and equivalents thereof.

What is claimed is:

1. A system for operating a game in association with a goods-related character/item, comprising:
a tag sticker attached to goods and storing game information related to the goods; and
a mobile terminal acquiring and storing the game information from the tag sticker through near field communication,
wherein the game information is stored in association with a game a user desires to play, such that the game information is applied to the game in execution of the game.

2. The system according to claim 1, wherein the game information comprises at least one of a character and an item related to the goods.

3. The system according to claim 1, wherein the tag sticker is kept in a security setting state before the goods are sold at a predetermined selling place, and kept in a security release state after the goods are sold at the selling place.

4. The system according to claim 3, wherein the mobile terminal acquires the game information from the tag sticker when the security setting state of the tag sticker is released.

5. The system according to claim 1, wherein the mobile terminal comprises:
a reader unit acquiring the game information from the tag sticker through near field communication;
a memory storing the game information acquired by the reader unit such that the game information is stored in association with the game a user desires to play; and
a game module executing the game according to user manipulation, and controlling the game information to be loaded from the memory and applied to the game in execution of the game.

6. The system according to claim 5, wherein the reader unit comprises a near field communication (NFC) reader which performs NFC communication with the tag sticker.

7. The system according to claim 1, further comprising:
a game server which updates the existing game information by receiving the game information from the mobile terminal and storing the game information in association with registration information of a user, and transmits the updated game information to the mobile terminal in response to a connection request from the mobile terminal by execution of the game.

8. A method for operating a game in association with a goods-related character/item, comprising:
by a reader unit of a mobile terminal, acquiring game information related to goods from a tag sticker through near field communication;
by a memory of the mobile terminal, storing the game information acquired by the reader unit such that the game information is stored in association with a game a user desires to play; and
by a game module of the mobile terminal, executing the game according to user manipulation, and controlling the game information to be loaded from the memory and applied to the game in execution of the game.

9. The method according to claim 8, wherein the acquiring game information comprises acquiring the game information from the tag sticker through near field communication with the tag sticker.

10. The method according to claim 8, further comprising:
by the game server, updating the existing game information by receiving the game information from the mobile terminal and storing the game information in association with registration information of a user; and
by the game server, transmitting the updated game information to the mobile terminal in response to the connection request from the mobile terminal by execution of the game.
